(19) United States
(12) Patent Application Publication
(10) Pub. No.: US 2009/0070816 A1
(43) Pub. Date: Mar. 12, 2009

(54) METHOD AND APPARATUS FOR SUGGESTING TELEVISION PROGRAMS TO A USER

(75) Inventors: Lukasz Szostek, Eindhoven (NL); Bartel Marinus Van De Sluis, Eindhoven (NL); Adolf Proidl, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,401

(22) PCT Filed: Oct. 24, 2005
(86) PCT No.: PCT/IB2005/053483

§ 371 Date: May 2, 2007

(30) Foreign Application Priority Data
Nov. 4, 2004 (EP) 04105520.3

(51) Int. Cl. H04N 5/445

(52) U.S. Cl. 725/46

(57) ABSTRACT

The invention relates to a method for suggesting television programs to a user, the method comprising: maintaining a set of preferred features of television programs, suggesting those television programs to the user for which at least one preferred feature is applicable, updating of the set of preferred features by input of the user whenever the user makes a choice from the presented television programs, presenting the preferred features which are applicable for the chosen television program whenever a program is chosen, accepting at least one preferred feature selected by the user, and updating the set of features with the help of the feature selected by the user. By selecting the feature regarded as most relevant for the user, the system obtains more information from the user, so that the learning process can be executed within a shorter time so that the user may dispose over a usefully limited selection in an earlier stage. The invention also relates to an apparatus for executing the method according to the invention.

The invention relates to a method of suggesting television programs to a user,

The invention further relates to an apparatus for recommending television programs to a user.

The invention also relates to a computer program product comprising computer executable code for programming a computer to carry out such method.

The invention yet further relates to a record carrier carrying such computer program product.

Most television viewers have the possibility to choose from a large number of television channels. It is thus difficult to obtain an overview of the available television programs.

This problem is only partly mitigated by systems allowing the recording of programs without knowledge of the broadcast channel or of the time a which the channels is broadcasted. These systems have made the recording process more user friendly but they have little influence on the ease of obtaining an overview of the available television programs.

US-A-2002 0 104 087 discloses a method for suggesting television programs to a user, the method comprising the maintaining a set of preferred features of television programs, the suggesting of those television programs to the user for which at least one preferred feature is applicable and the updating of the set of preferred features by input of the user whenever the user makes a choice from the presented television programs.

This method makes the offer of available television programs substantially more organized and accessible for the user. However this system requires input from the user about the preferences of the user or rather the features of programs in which the user has interest. Examples of features of programs are the genre of the program, like ‘action’, ‘drama’, ‘thriller’, ‘quiz’, ‘documentary’ etc., the actors, the nationality of the program, the name of the director, or the author.

In the system described in US-A-2002 0 104 087 the list of preferenced features is automatically updated whenever the user selects a program to be recommended. As each program has a number of features it takes a considerable time before the system learns the preferences of the user, as the user does not provide the information why he wants to see the program or rather why which of the features he regards as most relevant.

The aim of the invention is to provide a method wherein the preferences of the user are learned in a shorter time.

This aim is reached by such a method wherein whenever a program is chosen presenting the preferred features which are applicable for the chosen television program, accepting at least one preferred feature selected by the user, and updating the set of features with the help of the feature selected by the user.

By selecting the feature regarded as most relevant for the user, the system obtains more information from the user, so that the learning process can be executed within a shorter time so that the user may dispose over a usefully limited selection in an earlier stage. The term ‘updating’ herein is understood to encompass the adaptation of the set of preferred features to ‘learn’ the preferences of the user and to take account of changing interests of the user.

The invention further provides an apparatus for recommending television programs to a user, wherein the apparatus is adapted to maintain a set of preferred features of television programs and to recommend those television programs to the user for which at least one preferred feature is applicable, wherein the apparatus is adapted to update the set of preferred features from input of the user whenever the user makes a choice from the presented television programs, which apparatus is characterized in that it is adapted to present the preferred features which are applicable for the chosen program when a program is chosen to be programmed, that the apparatus is adapted to accept at least one preferred feature selected by the user of the chosen program and that the apparatus is adapted to update the set of features with the help of the feature selected by the user. This apparatus leads to the same advantages as the method described above.

It is noted that US-A-2002 0 104 087 discloses another kind of personal video recorders, which require an explicit feedback from the user. Most users are however reluctant to give feedback to the apparatus, as it requires explicit actions from the user. In the present invention this disadvantage is avoided as the feedback required from the user is only very limited, and because it is requested at times when the user is involved in handling the apparatus anyway, so that the single feedback question is not very demanding. Another advantage over this prior art is that the user is not only involved in the handling of the apparatus, but also in the selection of the program, so that the implicit question why he wants to view said program requires little effort.

In the above description the method and the apparatus are adapted to recommend a television program. The recommendation may be a recommendation to record said program on a video recorder. This video recorder may be a video cassette recorder but it may also be a digital video recorder either with a fixed hard disk or with exchangeable recordable disks. In both these situations, the method is executed by a personal video recorder and the chosen television program is programmed to be recorded by the personal video recorder. Then the apparatus may be a video recorder which is programmed to record the chosen television programs.

The recommendation may also be used as a recommendation to view the recommended program if the time at which the program is broadcasted is convenient for the user. The system may then be adapted to switch on a television set shortly before the begin of the program. In such an implementation the method is executed by a personal video recommender and the chosen television program is programmed to be displayed automatically. The apparatus may be a personal video recommender which is programmed to display the chosen television programs. The video recommender may be incorporated into a TV set.

The video recommender may however also be a separate component. This component may then be coupled to a television receiver or of a video recorder. The video recommender may however also be an integrated part of a TV set. Both as a separate unit and integrated in an apparatus the video recommender may form a part of an integrated home video system. An example of such a home video system is based on the Philips Connected Planet Architecture. In this system the different functions of the apparatus and the method of the invention can be implemented in several separate components of this system; it may be possible to implement the recommender function in a first component, the metadata function in another apparatus and the recording function in a third apparatus.

According to a preferred embodiment the choice of a preferred feature of a program is accepted as the choice of said program to be programmed. This leads to a further reduction of the actions required from the user. Consequently the preferred embodiment also provides an apparatus which is adapted to accept the selection of a preferred feature of a program as the choice of said program to be programmed.

Another preferred embodiment provides such a method comprising displaying a first menu with recommended television programs to be selected by the user and by, after selecting a program, displaying a second menu comprising a list of the preferred features applicable to the selected program and by accepting the selection of any feature of said program as a choice of said program to be programmed. This embodiment also provides an apparatus which is adapted to display a first menu with recommended television programs to be chosen by the user and that after the choice of a program, the apparatus is adapted to display a second menu comprising a list of the preferred features applicable to the chosen program wherein the apparatus is adapted to accept the selection of any feature of said program as a choice of said program to be programmed. This embodiment brings a further reduction of efforts from the user. Indeed when the user wants to check up for programs to be recorded, he may activate the first menu, showing a list of preferred programs. He may then select on of those programs to be recorded or viewed, preferably by pressing an area of the screen marked as such. When this program is selected the second menu appears on the screen, showing the selected program but also the features related to said program. The user may then confirm his selection by pressing the area of the screen which is marked with the feature. The system then obtains the information that the user wants to record or view the selected program but also which of the features relevant to said program he regards as relevant. The system then uses this information to update the list of preferred features of the user.

Preferably the apparatus comprises a touch screen which is adapted to display the first and the second menu thereon. The combinations of the two functions of the touch screen lead to a particular attractive use with this invention, as the menu's wherein the selections take place depend on choices made in earlier menus.

According to yet another embodiment, the apparatus is adapted to display the features of the television programs on the touch screen by icons. Features of television programs, like the genre of a movie are well suited to represent as icons, which makes the selection for a user much more intuitive.

As the invention requires some interaction with the user, it is convenient for the user to use a remote control unit as an input device for the control of the functions of the invention, that is the choice of the programs and the selection of the features of the programs. When a touch screen is incorporated into the remote control unit, the advantages of both embodiments are combined.

The use of a remote control unit offers not only the possibility to incorporate the control functions into the remote control unit, but also to incorporate the intelligent functions in the remote control unit. Such a remote control unit may adapted to communicate with its apparatus like a TV-set or a video recorder through the normal, standardized channels. The new adapted remote control unit may then be marketed as a separate unit to replace prior art remote control units, offering users the possibility to enjoy the advantages of the present invention without buying new equipment.

Subsequently the present invention will be described with the help of the accompanying drawings in which:

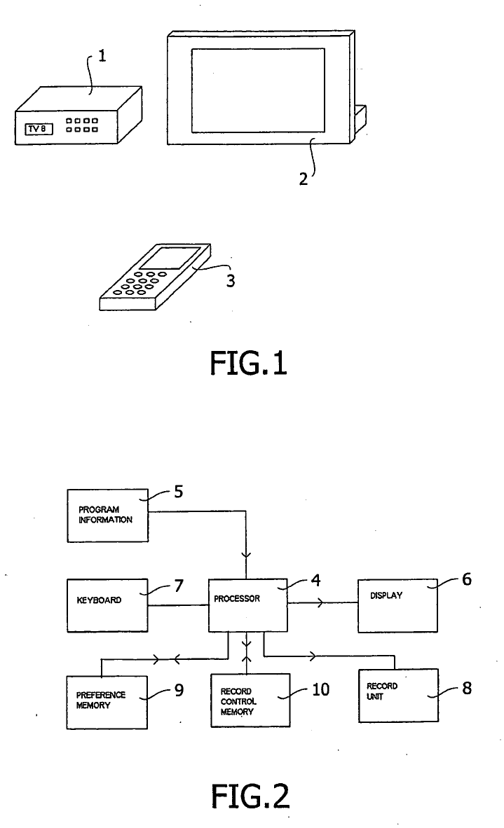

FIG. 1 shows a diagram view of a personal video recorder, a display unit and a remote control unit in which the invention may be incorporated;

FIG. 2 shows a diagram of an embodiment of the invention; and

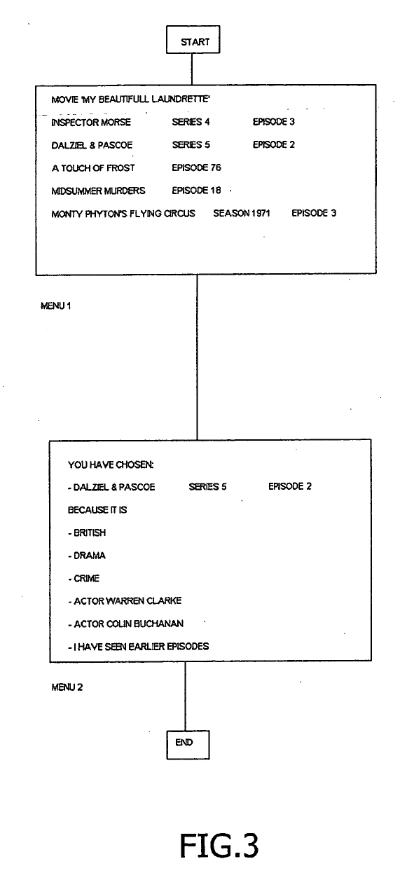

FIG. 3 shows a flow chart explaining the invention.

The invention is applicable to a system as depicted in FIG. 1, comprising a personal video recorder 1, a display unit 2 like a television set and a remote control unit 3. The system may be part of a home cinema system comprising further components which will not be further elucidated as they are not relevant for the invention.

The personal video recorder 1 is adapted to show the user the programs scheduled for the next week or other limited period for which the schedules are available. To reduce the number of programs to be shown to the user, the personal video recorder is adapted to show a limited selection of programs in accordance with the preferences of the user. To be able to make such a selection the personal video recorder needs the preferences of the user. Prior art personal video recorders require the user to input his preferences as a part of the installation procedure. Most users find this troublesome. Further it may lead to suggestions outside the area of interest if the initial input of preference is not executed properly. Another disadvantage is that the preferences, of the user may change with time.

Another kind of personal video recorders is known wherein the recorder registers the preferences of the user from the programs he wants to record. Although this is convenient for the user, the recorder needs a long learning time.

The personal video recorder according to the invention avoids these problems by asking for the users preferences when the user makes his choice for a program to be recorded.

The personal video recorder comprises the following components which are shown in the diagram depicted in FIG. 2. The main component is processor 4 controlling all the actions to be taken. The processor 4 is connected to a source 5 of program information. This source may take different forms like a decoder to decode teletekst, ceefax or other programming information incorporated into the television signal, or a decoder adapted to obtain the schedules from the Internet. Other sources of program schedules are not excluded. The personal video recorder comprises also a display 6 and an input device 7 functioning as an interface with the user. Just as a normal video recorder the personal video recorder according to the invention also comprises a record unit 8, often combined with a playback unit.

In this respect it is noted that the video record unit may be adapted to record on video cassettes in an analogue fashion, but it is preferred that the unit is digital record unit adapted to record the video signal in a digital format. This may be on a DVD format on exchangeable disks, but it may also be on an apparatus equipped with a fixed, that is non-exchangeable hard disk.

Finally the unit comprises a preference memory 9 for storing the preferences and a record control memory 10 for storing the times, channels and identifications for the programs to be recorded. It is noted that the personal video recorder will contain other components needed for its functions, but in this description only those components have been mentioned which are relevant to the present invention.

Subsequently the actions of the personal video recorder will be described. Therefore it is assumed that the preference memory comprises already some preferred features of the user.

This invention makes use of the fact that each program on the television possesses features. Features are the nationality of the program, the genre of the program, like a detective or crime, a documentary or a sports program, the director, the main actors, the presenter, etc. It is noted that not all of the features can be connected to each of the genres.

It is assumed that the user switches his personal video recorder on, or rather that he brings the recorder from the standby condition to the active condition, after which the display 6 shows a list of programs according to the preferences of the user. If the list is long, it may scrolled. The processor 4 of the recorder 1 has obtained the particulars including the features of the programs for the next few days or the next weeks from the program information source 5. The shown programs all have at least one feature which is within the list of the users preferred features in the preference memory 9.

An example of such a list is depicted in the flow chart of FIG. 3. Herein the list forms the first menu. The user may then make a choice from said first menu by pressing a button of the keyboard beside the chosen program or by pressing on the name of the program when a touch screen is used instead of the combination of a display 6 and input device 7.

The system then displays a second menu, also depicted in FIG. 3 wherein the name of the chosen program and its features are shown. The user may then confirm the selected program so that it will be scheduled for recording. According to a preferred embodiment the user confirms the choice by selecting one of the features of the chosen program, for instance the genre thereof. The processor notices this selection and it will be used as input for the learning process which process itself does not form a part of the present invention.

The user may then end the programming process or he may want to program another program form the list.

Numerous variations are possible to the concept described above. It is for instance possible that the user is offered the possibility to indicate more than one feature and the apparatus is adapted to process these two features.

Another variation resides in the way of presenting the features. In the embodiment described above the features of the programs are displayed in words; it is also possible to display these features by icons or symbols.

Yet another variation resides in the way the menu is presented. In the above embodiment the menu's are described in two steps, a first step to make the initial choice and a second step to confirm the choice by the selection of the feature regarded as most important. It is possible to combine these two steps, by displaying a matrix of programs with the features connected to those programs. The choice of the program and the selection of the feature regarded as most important can be achieved in a single action by the selection of the relevant feature of the chosen program. This variation is advantageously combined with the use of a touch screen and possible scrolling facilities in both directions of the screen.

A simple implementation of the invention is located in a personal video recorder adapted to record programs and to reproduce these at will. It is however also possible to implement the invention a ‘personal video recommender’ which is adapted to switch on the television set when a program is scheduled in which the user has indicated his interest. This avoids that the user forgets to look at the program.

The invention will usually be implemented in the apparatus itself, that is in the personal video recorder. Usually this kind of apparatus is provided with a remote control. The remote control will then have extra buttons and possible a touch screen allowing the invention to be carried out. It is however also possible to make use of the screen of the TV as is common with video recorders.

As the components needed for the implementation of the invention have a small dimensions. This offers the possibility to incorporate the invention in a remote control unit and to sell this on its own to be used with a personal video recommender.

1. Method for suggesting television programs to a user, the method comprising:
maintaining a set of preferred features of television programs;
suggesting those television programs to the user for which at least one preferred feature is applicable,
updating of the set of preferred features by input of the user whenever the user makes a choice from the television programs,
characterized by
presenting the preferred features which are applicable for the chosen television program whenever a program is chosen,
accepting at least one preferred feature selected by the user, and
updating the set of features with of the feature selected by the user.

2. Method as claimed in claim 1, characterized in that the method is executed by a personal video recorder and that the chosen television program is programmed to be recorded by the personal video recorder.

3. Method as claimed in claim 1, characterized in that the method is executed by a television set and that the chosen television program is programmed to be displayed automatically.

4. Method as claimed in claim 1, characterized in that the method is executed by a personal video recommender.

5. Method as claimed in claim 1, characterized in that the choice of a preferred feature of a program is accepted as the choice of said program to be programmed.

6. Method as claimed in claim 5, characterized by displaying a first menu with recommended television programs to be selected by the user, displaying a second menu comprising a list of the preferred features applicable to the selected program, and accepting the selection of any feature of said program as a choice of said program to be programmed.

7. Apparatus comprising a memory, characterized in that the memory is programmed to execute a method as claimed in claim 1.

8. Apparatus for recommending television programs to a user, wherein the apparatus is adapted to maintain a set of preferred features of television programs and to recommend those television programs to the user for which at least one preferred feature is applicable, wherein the apparatus is adapted to update the set of preferred features from input of the user whenever the user makes a choice from the television programs, characterized in that the apparatus is adapted to present to the user the preferred features which are applicable for the chosen program when a program is chosen to be programmed, that the apparatus is adapted to accept at least one preferred feature selected by the user of the chosen program and that the apparatus is adapted to update the set of features with assistance of the feature selected by the user.

9. Apparatus as claimed in claim 8, characterized in that the apparatus is a video recorder which is programmed to record the chosen television programs.

10. Apparatus as claimed in claim 8, characterized in that the apparatus is a TV set which is programmed to display the chosen television programs.

11. Apparatus as claimed in claim 8, characterized in that the apparatus is a personal video recommender which is programmed to control a TV set or a video recorder to which it is connected.

12. Apparatus as claimed in claim 8, characterized in that the apparatus is at least partially incorporated into a remote control unit.

13. Apparatus as claimed in claim 8, characterized in that the apparatus is adapted to accept the selection of a preferred feature of a program as the choice of said program to be programmed.

14. Apparatus as claimed in claim 8, characterized in that the apparatus is adapted to display a first menu with recommended television programs to be chosen by the user and that after the choice of a program, the apparatus is adapted to display a second menu comprising a list of the preferred features applicable to the chosen program wherein the apparatus is adapted to accept the selection of any feature of said program as a choice of said program to be programmed.

15. Apparatus as claimed in claim 8, characterized by a touch screen, and that the apparatus is adapted to display the first menu and the second menu on the touch screen.

16. Apparatus as claimed in claim 15, characterized in that the apparatus is adapted to display the features of the television programs on the touch screen by icons.

17. Apparatus as claimed in claim 15, characterized in that the touch screen is incorporated into a remote control unit.

18. Computer program product comprising computer executable code for programming a computer to carry out the method as claimed in claim 1.

19. Record carrier carrying the computer program product as claimed in claim 18.
